(19) United States
(12) Patent Application Publication
(10) Pub. No.: US 2026/0249236 A1
(43) Pub. Date: Aug. 27, 2026

(54) ESTIMATION OF THE REMAINING SERVICE LIFETIME OF THE CO2 REMOVAL MEMBRANES USING PERMEANCE DATA

(71) Applicant: Petróleo Brasileiro S.A. – Petrobras, Rio de Janeiro (BR)

(72) Inventors: Thiago Koichi ANZAI, Rio de Janeiro (BR); Gesner Andrade Nery JUNIOR, Rio de Janeiro (BR); Gabriel Alexandre VASCONCELOS, Rio de Janeiro (BR)

(21) Appl. No.: 19/537,016

(22) Filed: Feb. 11, 2026

(30) Foreign Application Priority Data
Feb. 25, 2025 (BR) 1020250036940

(51) Int. Cl. B01D 53/22; B01D 61/02; B01D 61/14

(52) U.S. Cl. CPC B01D 53/22; B01D 61/025; B01D 61/149

(57) ABSTRACT

The present disclosure aims at proposing a methodology for estimating the Remaining Service Life (RSL) of the membranes for removing CO₂ from natural gas. The proposed method defines a reference value for the membrane system based on design data and, through appropriate corrections, compares the operational and reference permeances to estimate the service lifetime of the equipment. The proposed methodology was implemented for an oil production platform in two steps: an “offline” step, whose objective was to observe the degradation of the membrane performance in the long term; and an “online” step, available on the SmartMonitor platform for real-time monitoring of the performance indicators and RSL. The obtained results have proven consistent with those observed by the monitoring team and coherent with the operation.

### CROSS-REFERENCE

This application claims priority to Brazilian patent application Ser. No. 1020250036940, filed Feb. 25, 2025, which is incorporated herein in its entirety by reference thereto.

### FIELD

The present disclosure pertains to the field of oil and gas engineering. More specifically, the present disclosure relates to a method for estimating the remaining service life (RSL) of a gas treatment membrane, particularly for CO₂ removal, based on the reference permeance of the membrane.

### BACKGROUND

The method of separating CO₂ from natural gas by using polymeric membranes is widely employed in the production units in the pre-salt fields. The high gas flow rate associated with CO₂ concentrations that can reach up to 60% makes this application economically advantageous. However, the inefficient monitoring or lack of standardization of this equipment often results in an accelerated degradation of the membranes, reducing their expected service life. To provide an efficient predictive monitoring of the membrane systems, it is essential to robustly and coherently estimate indicators such as the remaining service lifetime (RSL) of these equipment. The lack of predictability resulting from the absence of such indicators leads to high costs due to reactive maintenances, low separation efficiency, and production losses. Currently, there are no methods available on the market or in academia capable of predictively monitoring the CO₂ removal system, providing the user with an indication of the time in which the membranes can still operate until they reach a certain minimum quality criterion.

Due to the absence of methods for the predictive monitoring of the CO₂ removal membranes, the monitoring of these equipment is generally based only on measurable data, such as the CO₂ content in the treated gas. However, it is important to highlight that these measurements are influenced by other process variables, which can obscure information about the actual condition of the membranes. In addition, these uncertainties prevent the reliable estimation of the remaining service lifetime (RSL) of these equipment. As a result, it is rare for any indicator of this type to be calculated for this system.

### STATE OF THE ART

Document U.S. Pat. No. 11,992,803B2, titled “Method of determining remaining service lifetime of membrane for separation process,” discloses that membranes used in membrane separation technologies change over time due to changes in the physical characteristics of the membrane. Predicting the remaining service life of a membrane is performed by fitting a membrane evolution model to the real-time performance characteristics recorded for the membrane, and by comparing the subsequent performance characteristics of the membrane to the evolution model. Updating an evolution model during the membrane operation improves estimates of the remaining service life of the membrane and allows for precise estimates of the estimated end of the service life of the membrane. A method is proposed for estimating the remaining service life (RSL) of a gas separation membrane unit to achieve the membrane replacement in a prognostic or predictive manner, rather than a responsive manner based on performance criteria that exceed a predetermined replacement criterion. The disclosed method is applicable to estimates of the service lives of many different types of membranes, not just membranes used in gas separation. A feature of a membrane separation system amenable to using the method disclosed herein is that real-time performance data of the membrane operation can be recorded during the membrane operation for the feed flow, permeate flow, and non-permeate flow associated with a membrane separation system. The determination of the remaining service life is performed by using a physical model, trained on data acquired by means of a non-destructive in situ monitoring of membrane operations.

### BRIEF SUMMARY

The proposed disclosure presents a methodology for estimating the remaining service lifetime (RSL) in CO₂ removal systems using polymeric membranes, based on indicators consistent with the physics of the membrane system. The disclosure comprises a combination of: (i) measured data from the membrane system, obtained through the PI historian, which collects, processes, and stores process plant data in real time; (ii) design data for the elaboration of the temperature reference curve; and (iii) membrane performance indicators (KPIs—Key Performance Indicators) generated by a specially developed library and optionally integrated into a specially developed web platform. The proposed procedure is divided into two steps: an “offline” step and an “online” step. In the “offline” step, the design data is used to obtain a reference value for the KPI of the membranes. This reference value allows for comparison of operational KPI values with those expected during the design phase. In the “online” step, a comparison is made between the design reference value and the KPI calculated under the current operating conditions of the membranes. For this comparison to be precise, it is necessary to eliminate the effects of the process conditions on the KPI. The disclosure proposes methods for normalizing the KPI in terms of temperature and flow, in addition to suggesting a coherent way to obtain an average KPI for the membrane system. Correcting the KPI estimated by the library for the same base temperature is crucial, as the KPI varies with temperature, being affected by operational adjustments in the gas treatment plant. Without this correction, the unadjusted KPIs could lead to erroneous conclusions about their behavior over time, attributing changes to temperature variations in the gas treatment process, and not to the natural degradation of the polymeric membranes. The flow normalization aims at making the KPI independent of variations in the gas flow rate and alterations to the number of aligned membranes (variations in permeation area). With these adjustments, monitoring the average KPI of the membrane system over time allows extrapolating the dynamic degradation behavior of the membranes, enabling the prediction of the remaining service life. To ensure the robustness of the methodology, the disclosure uses a robust linear regression on the KPI data.

### BRIEF DESCRIPTION OF THE DRAWINGS

The present disclosure will now be described with reference to the typical embodiments thereof and also with reference to the appended drawings, in which:

FIG. 1 is a flowchart representing the method according to the present disclosure;

FIG. 2 is a flowchart representing the monitoring steps for inferring the permeance according to the present disclosure;

FIG. 3 is a flowchart representing the dew point calculation algorithm according to the present disclosure;

FIG. 4 is a schematic representation of the gas flows related to a CO₂ removal membrane according to the present disclosure;

FIG. 5 is a representative graph of the permeance trends calculated versus temperature for different CO₂ contents in the waste gas according to the present disclosure;

FIG. 6 is a schematic representation of the proposed methodology to simulate the effect of the membrane capacity loss according to the present disclosure;

FIG. 7 is a representative graph of the correction of the operational permeance for reference temperature according to the present disclosure;

FIG. 8 is a comparative graph of different linear regression techniques;

FIG. 9 is a representative graph of estimated CO₂ permeances according to the present disclosure;

FIG. 10 is a representative graph of CO₂ permeances corrected to fit within 3% CO₂ according to the present disclosure;

FIG. 11 is a representative graph of CO₂ permeances corrected to fit within 6% CO₂ according to the present disclosure;

FIG. 12 is a representative graph of CO₂ permeances corrected to fit with 10% CO₂ according to the present disclosure;

FIG. 13 is a representative graph of the RSL estimate according to the present disclosure;

FIG. 14 is a screenshot of the methodology according to the present disclosure implemented in real time on the SmartMonitor platform.

### DETAILED DESCRIPTION

Specific embodiments of the present disclosure are described below. In an effort to provide a concise description of these embodiments, all features of an actual implementation may not be described in the specification. It should be appreciated that in the development of any actual implementation, as in any engineering project or design, numerous specific implementation decisions must be made to achieve the specific objectives of the developers, such as compliance with system and business-related constraints, which may vary from one implementation to another. In addition, it should be appreciated that such a development effort may be complex and time-consuming, but would nevertheless be a routine design and manufacturing undertaking for those of common skill having the benefit of this disclosure.

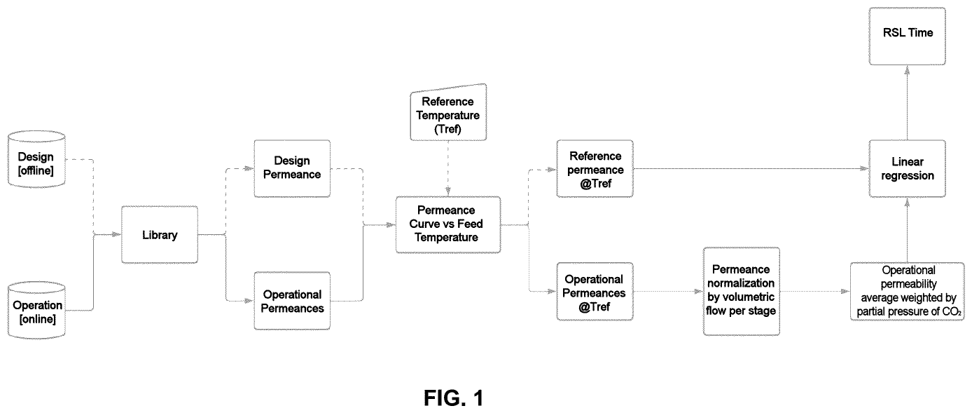

FIG. 1 schematically presents the methodology developed for estimating the RSL of the CO₂ removal membranes, from data acquisition, recorded in the PI system (PI System™), to model fitting for prediction. The concept proposed by the flowchart in FIG. 1 foresees the existence of a reference KPI and a current KPI, calculated under the operating conditions. In FIG. 1, the dashed line shows the calculation flow performed offline, while the solid line represents the calculations made in real time, by using the information calculated by the offline step.

Over time, the difference between the reference KPI and the current KPI reflects the degradation and aging of the membranes. The present disclosure adopts permeance as the standard KPI and its reference as resulting from the design data sheets. All permeances shown are presented in MNm³/(dia·m²·bar).

The methodology will be explained below based on practical cases observed in an actual oil extraction and production plant, which served as validation for the proposed methodology.

### Curve of Reference Permeance Values

The calculation of the reference permeance values was based on the design cases presented in the data sheet of the polymeric membrane manufacturer. For the plant in question, the documentation presents eight independent cases, where conditions such as CO₂ content in the feed, flow rates, and temperatures varied. All scenarios produced, in the second stage of membrane separation, waste streams with a CO₂ content of 3%, varying the number of trains aligned for the treatment. The original design data set, referred to here as “PRJ,” was presented to a library specially developed for the present methodology in order to calculate the permeances of each of the eight cases. Throughout the present text, a library is defined as a set of instructions organized in a structured and generic way, or, in other words, as ready-made code packages that can be exported for use in different projects. The results obtained allowed us to evaluate the effect of the feed temperature on the permeances.

### Calculation of the Permeances of Each Membrane

The real-time monitoring of a membrane separation unit on an industrial offshore platform was based on two inferred pieces of information: selectivity and dew point temperature of the waste stream, i.e., the gas stream treated by the membrane. The first piece of information is linked to the estimated parameters: the permeances. Once the permeance estimation procedure is completed, the selectivity calculation is performed and monitored. The selectivity is calculated as the ratio between two permeances of key components, which in this case are CO₂ and CH₄ (methane). Thus, the selectivity provides overall information about the process: whether the membrane is operating within the appropriate conditions or whether it is facing a problem that is affecting the gas separation performance.

The second piece of information is associated with the energy balance and thermodynamic equations. The dew point temperature is calculated sequentially after the waste flow rate data are optimized in the parameter estimation step. This information is fundamental for the operation and service life of the membranes, as the condensation of water and impurities on the membranes will damage the same. Therefore, a threshold safety margin (ΔT=10° C.) is monitored between the current temperature of the waste stream and its dew point temperature. The monitoring of the membrane separation unit on an industrial offshore platform is carried out at the waste stream outlet because, at this point, the curves between the current temperature and its dew point converge, forming the most critical point of the process. This effect occurs due to two processes: first, by cooling the stream due to the Joule-Thomson effect; second, by increasing the dew point temperature due to the concentration of hydrocarbons (mainly heavy ones) along the membrane.

### Data Reconciliation, Parameter Estimation, and Monitoring

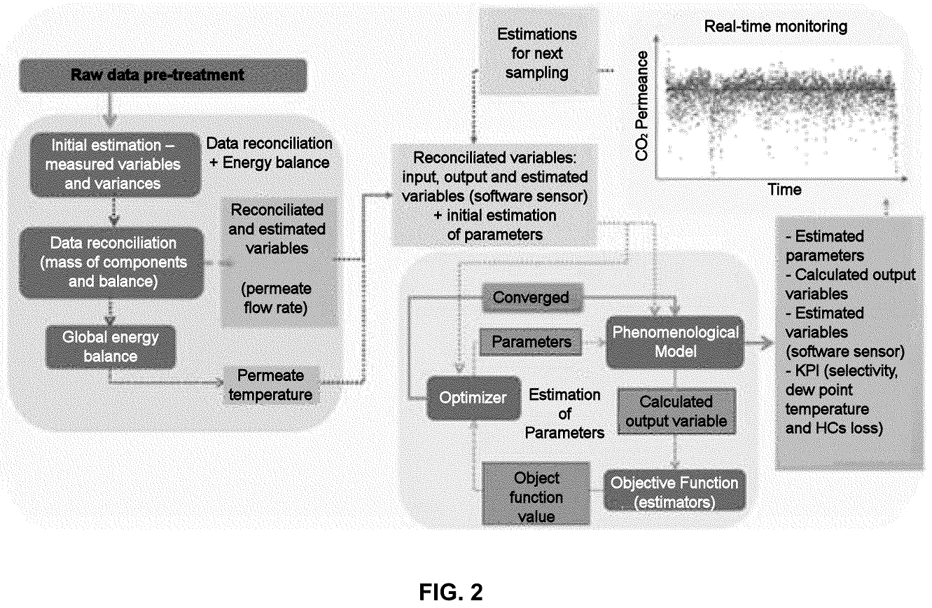

To provide the necessary monitoring information, the data pre-processing steps, Data Reconciliation (DR), Global Energy Balance (GEB), and Parameter Estimation (PE) were sequentially implemented and before the monitoring step, as shown in FIG. 2. In the graph of this figure, the sampling frequency is 5 minutes, and the CO₂ Permeance is given in MSm³/(dia·m²·bar). The measured variables, unmeasured process variables, and KPIs mentioned in FIG. 2 are as follows:

### —Measured Variables:

Flow rates: Total Feed (F); Total Retentate (R); Train Retentates A, B, and C (RA, RB, and RC) [kNm³/h];
Molar composition: C₁ (methane), C₂ (ethane), C₃ (propane), iC₄ (i-butane), iC₅ (i-pentane), nC₄ (n-butane), nC₅ (n-pentane), CO₂ (carbon dioxide), N₂ (nitrogen), H₂S (hydrogen sulfide) and C₆₊ (pseudo component of the fractions heavier than pentane) in the 3 flows [%];
Pressures: Feed (Pf), Retentate (Pr) and Permeate (Pp) [kPa]; and
Temperatures: Feed (Tf) and Retentate (Tr) [° C.].

### —Unmeasured Variables:

Flow rate: Total Permeate (P) [kNm³/h]; and
Temperature: Permeate temperature (Tp) [° C.].

### —KPIs:

Selectivity;
Dew point temperature; and
Hydrocarbon (HC) loss.

To minimize instrumentation errors, identify biases, and estimate unmeasured process variables, the DR step was essential. According to de Menezes et al. (de Menezes, D. Q. F.; de Sá, M. C. C.; Fontoura, T. B.; Anzai, T. K.; Diehl, F. C.; Thompson, P. H.; Pinto, J. C. Modeling of spiral wound membranes for gas separations—Part II: Data reconciliation for online monitoring. Processes 2020, 8, 1035), the data acquisition and pre-processing steps precede the DR and GEB steps. After pre-processing the raw data, the DR and GEB steps estimate the flow rate and temperature of the permeate flow, providing more information for the PE step.

### Parameter Estimation

The first procedure performed before PE was the selection of the number of parameters of the phenomenological model to be estimated. In fact, the most important parameters of the dense membrane models are the permeances of each component (in the studied case, twelve components). Therefore, some hypotheses of the possible parameters were raised according to the process configuration. To reduce the number of parameters and avoid overparameterization of the model, it was assumed that the permeances (different for components) are the same for all membrane modules.

The second procedure performed was the reparameterization of the 11 permeance parameters (Sᵢ, i=1 . . . nc). This procedure was necessary due to numerical and convergence problems of the model, encountered during PE. Thus, a normalization constant of the permeances was implemented in the model

$$( {S}_{max} = 3 \times 1 {0}^{- 7} [ \frac{{MSm}^{3}}{dia \times {m}^{2} \times bar} ] ,$$

maximum limit found during the numerical problems of the model).

The last procedure involved generating data to simulate the linear loss of hydrocarbons (HC) over time in an actual membrane separation unit of an industrial offshore platform. The data sets represented various degrees of HC loss, ranging from low (18%) to high (23%). The HC simulations were conducted based on the assumption that the permeability of hydrocarbons, represented as S_{ci}, in the hydrocarbon mixture decreases with increasing chain length and molecular weight: S_{C1}>S_{C2}>S_{C3}> . . . >S_{C8}. This implies that the permeation behavior of methane (S_{C1}) is intrinsically linked to that of other hydrocarbons, with shorter chain molecules exhibiting higher permeability coefficients. For these simulations, it was assumed that any increase in S_{C1} leads to a proportional linear increase in the permeability of the other hydrocarbons (S_{Ci}, i=2 . . . 8), while satisfying the overall mass balance of the system at the same time. This linear relation ensures that the overall dynamics of the system remain consistent and that the principles of mass conservation are maintained throughout the permeation process.

Next, the PE procedure was applied to estimate the permeances and verify whether the procedures for parameter number selection and reparameterization thereof solved the convergence and numerical stability problem. The optimization method used in the cases was the Broyden-Fletcher-Goldfarb-Shanno (BFGS) procedure, as well known in the technique, implemented in the minimization function of the Scipy optimization library.

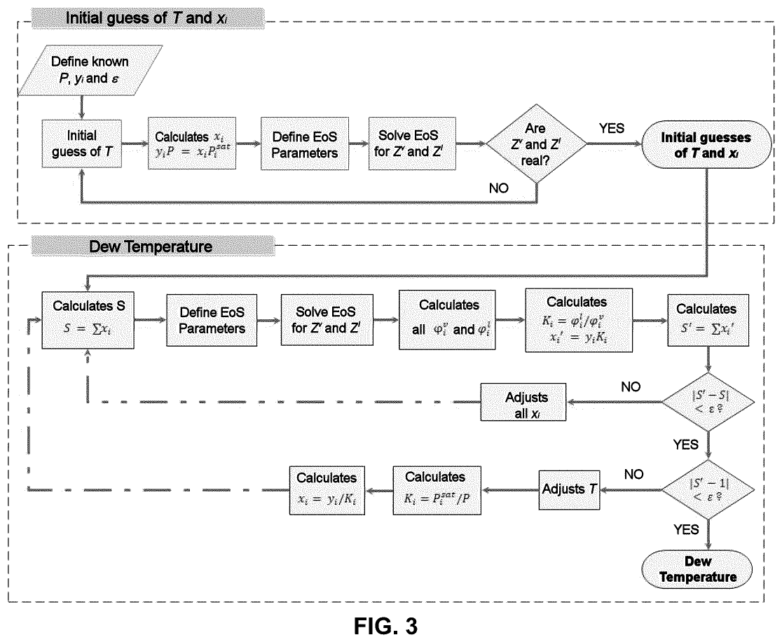

The determination of the dew point temperature follows the iterative algorithm introduced by O'Connell and Haile (O'Connell, J.; Haile, J. Thermodynamics: Fundamentals for Applications; Cambridge University Press: Cambridge, UK, 2005), as illustrated in FIG. 3, which describes an iterative algorithm to calculate the dew point temperature, where:
P: System pressure;
yi: Mole fraction of component i in the vapor phase;
T: System temperature;
xi: Mole fraction of component i in the liquid phase;
Psat: Saturation pressure of component i at the system temperature;
EoS: Equation of state used to calculate the thermodynamic properties of the system;
Z: Compressibility factor, calculated from EoS;
ZL: Compressibility factor of the liquid phase;
ZV: Compressibility factor of the vapor phase;
φ: Fugacity coefficient of component i;
φL: Fugacity coefficient of component i in the liquid phase;
φV: Fugacity coefficient of component i in the vapor phase;
Ki: Equilibrium constant of component i (Ki=φL/φV);
x′i: New mole fraction of component i in the liquid phase, calculated based on the equilibrium constant;
S: Sum of mole fractions in the liquid phase (S=Σxi);
S′: Sum of the new mole fractions in the liquid phase (S′=Σx′i);
ε: Tolerance for algorithm convergence; and
ξ: Tolerance for convergence of the sum of mole fractions (S′).

The 2-D model used allows the calculation of the dew point temperature along the tube and the surface of the membrane layer. This capability facilitates the identification of specific locations where the membrane plasticization may possibly occur, according to Fontoura et al. (Fontoura, T. B.; de Sá, M. C. C.; de Menezes, D. Q. F.; Oechsler, B. F.; Melo, A.; de O. Campos, L. F.; Anzai, T. K.; Diehl, F. C.; Thompson, P. H.; Pinto, J. C. Modeling of spiral wound membranes for gas separations. Part III: A non-isothermal 2D permeation model. Chem. Eng. Res. Des. 2022, 177, 376-393).

### Modeling

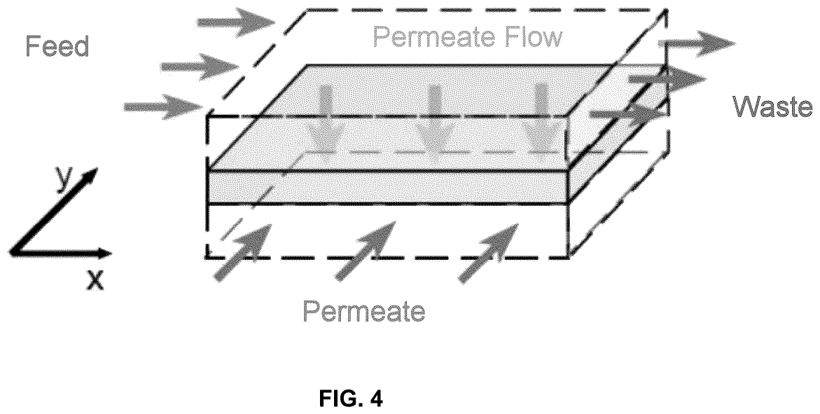

FIG. 4 shows a schematic representation of the elementary volume of the spiral wound membrane layer used for the development of the proposed model, comprising the permeate and retentate (waste) sections. The mass balance and the energy balance used were previously described by Dias et al. (Dias, A. C. S.; De Sá, M. C. C.; Fontoura, T. B.; Menezes, D. Q.; Anzai, T. K.; Diehl, F. C.; Thompson, P. H.; Pinto, J. C. Modeling of spiral wound membranes for gas separations. Part I: An iterative 2D permeation model. J. Membr. Sci. 2020, 612, 118278) and Fontoura et al., respectively, according to which the flow of waste occurs only along the x-direction, while the flow of permeate occurs along the y-direction. In addition, the following considerations and assumptions are applied in the membrane model:
1. The permeation mechanism can be described by the solution-diffusion model;
2. The competitive diffusive behavior was not considered;
3. The process operates under steady-state conditions;
4. Very rapid permeation through the membrane barrier and negligible gas accumulation on the membrane;
5. The membrane has uniform thickness and properties;
6. The pressure drops of the feed and permeate gas flows along the membrane surface are negligible (as observed in actual industrial settings);
7. The thermodynamic behavior of the gas can be described by the Virial Equation (Scholz, M.; Harlacher, T.; Melin, T.; Wessling, M. Modeling Gas Permeation by Linking Non-ideal Effects. Ind. Eng. Chem. Res. 2013, 52, 1079-1088);
8. Uniform composition and temperature conditions in the feed flow;
9. The permeate flow is subject to temperature changes due to the Joule-Thomson effect;
10. The heat loss to the environment is negligible.

### Estimation of RSL of the Membranes

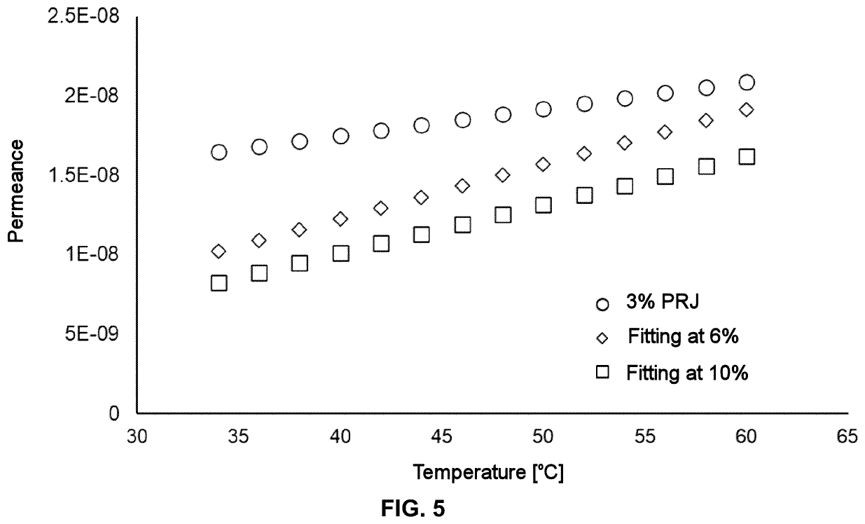

FIG. 5 shows the behavior of the permeance estimated by the library applied to the membrane manufacturer's data, which showed a linear increase with the feed temperature in the evaluated range.

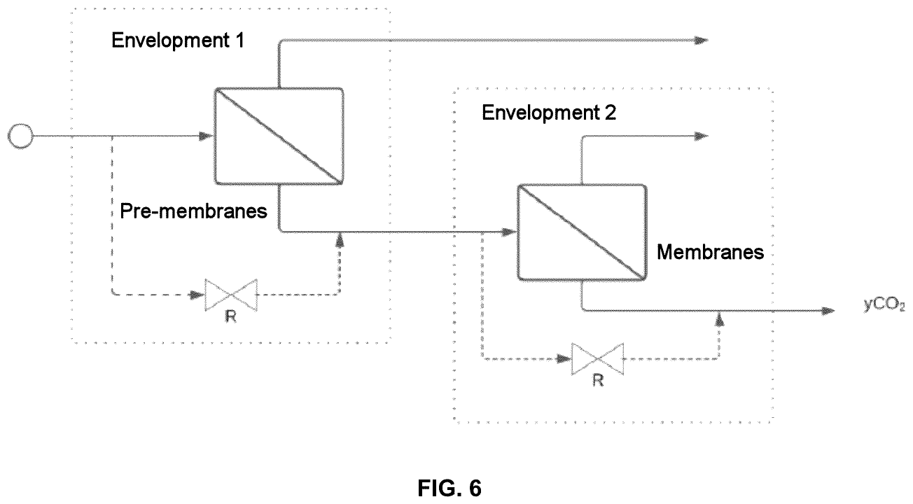

As can also be seen from FIG. 5, two other gas fitting cases were evaluated, with CO₂ contents of 6% and 10%, from the perspective that the 3% CO₂ fitting assumption, imposed by the original design data, might be too restrictive from a practical point of view. To generate new data with different separation efficiencies, the original manufacturer's scenarios were systematically “corrupted”: as illustrated in FIG. 6, two “by-pass” streams were created to emulate the membrane capacity loss. In this way, under the assumption that the two stages (pre-membrane and membrane) lose capacity similarly, it is possible to adjust the feed stream ratio (R) in the “by-pass” in order to obtain the desired yCO₂ value in the waste stream. This methodology allows for the rapid calculation of different CO₂ contents in the treated gas while maintaining the coherence with the original scenarios and respecting the mass balances. Finally, it should be noted that, although the calculation can be performed for any CO₂ content, the choice of values of 6% and 10% was due to restrictions on the exported gas network foreseen for the aforementioned actual oil extraction and production plant. Other content values can be freely chosen according to specific applications, without departing from the scope of the present disclosure.

### Temperature Correction

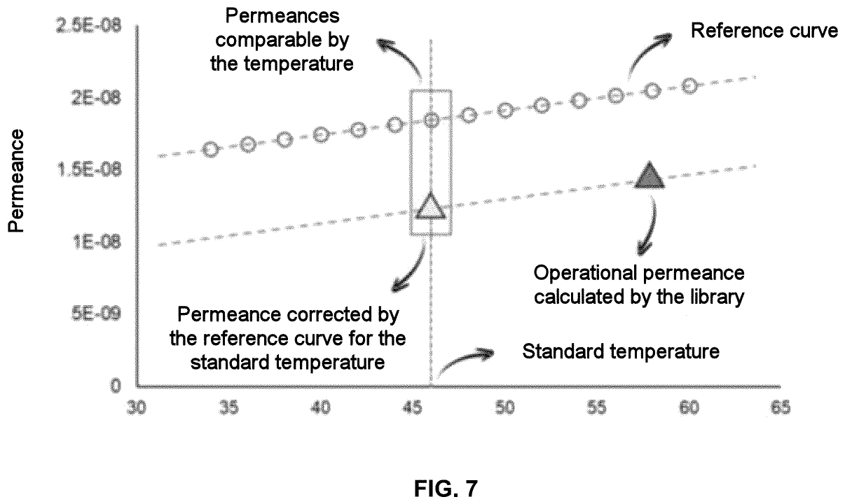

Obtaining a representative curve of the permeance behavior at different feed temperatures (FIG. 5) is convenient because it allows: i) from the definition of a standard temperature, fixing a single reference value for permeance at that temperature, ii) from the obtained Permeance x Temperature curve, correcting the permeance inferences generated by the library for the defined standard temperature and, finally, iii) after this correction, comparing the permeances estimated by the library over time for different temperature conditions. FIG. 7 shows how, from the obtained permeance versus temperature curve, the correction is performed on the operational permeance calculated by the library. In general, it is assumed that the KPI responds to the temperature in the same way as the results obtained in the data sheets, that is, it presents the same slope as the line estimated by the data sheet. With this, it is possible to bring both permeances (operational and reference) to the same base temperature. The temperature considered was 45° C.; however, the present disclosure is not limited to this. Specific applications may select any other base temperature.

Correcting the permeance estimated by the library for the same base temperature is important because, as permeance is a function of temperature, it changes according to the operational adjustments made in the gas treatment plant. Thus, if this correction were not performed, the uncorrected permeances could lead to erroneous inferences about their own behavior over time, which could be linked to temperature changes in the gas treatment process and not to the natural degradation of the polymeric membranes.

### Normalization of the Permeance by the Flow

Following the steps of the methodology presented in FIG. 1, after correcting the permeance by temperature, the normalization of this permeance by the gas flow in that stage is performed. The normalized permeance by the flow,

$${P}_{i , j}^{*}$$

of a component j in stage i can be calculated from equation 1 below:

$${P}_{i , j}^{*} = \frac{{P}_{i , j}^{T}}{{Flow}_{i , j}} \qquad ( 1 )$$

The gas Flow_{i,j} of component j in stage i is calculated by equation 2:

$${Flow}_{i , j} = \frac{{Q}_{i} {y}_{i , j}}{{A}_{i}} \qquad ( 2 )$$

where the permeation area of stage i of membranes (Aᵢ) is calculated by equation 3:

$${A}_{i} = {\sum }_{k = 1}^{3} F {V}_{k , i} {A}_{k , i} \qquad ( 3 )$$

where, in the equations above:

$${P}_{i , j}^{T}$$

is the permeance corrected by temperature T of component j in stage i;

$${P}_{i , j}^{*}$$

is the flux-normalized permeance of component j in stage i;
Flow_{i,j} is the gas flow of component j in stage i;
Qᵢ is the volumetric gas flow rate, under normal conditions, in stage i;
y_{i,j} is the gas content of component j in stage i;
Aᵢ is the permeation area of the membranes of stage i;
FV_{k,i} is the status of the inlet valve of the k-train of the stage i of membranes; and
A_{k,i} is the area corresponding to the elements of the k-train of the stage i of membranes.

In the specific case of monitoring the service life of CO₂ membranes, the component of interest is CO₂ itself. Thus, in the equations above, the parameters used correspond to those of the CO₂ component. This normalization aims at making the permeance term independent of variations in gas flow rate and alterations to the number of aligned membranes (variations in permeation area). Thus, the normalized permeance facilitates and allows to monitor the degradation of the performance of the membranes over time in a more robust way because it is more insensitive to operational variations of the process.

### Obtaining an Average Permeance of the System

As described earlier, a CO₂ removal system will be subject to different operating conditions (flow rate, temperature, gas composition, pressure, and permeation area). Due to these different operating conditions, the permeance of each separation stage varies unevenly over time.

In this way, given that the permeances of the stages are distinct from each other, having two permeance values, despite providing more information about the state of the plant, makes the interpretation of the service lifetime of the CO₂ removal system more complex, since one membrane stage may be more degraded than another. Thus, a normalized permeance is estimated for each stage, as detailed in the previous steps, and, from these two corrected permeances, it is possible to calculate the average permeance of the entire CO₂ removal system. Calculating this average value is of interest because it summarizes, in a single variable, the degradation of both membrane stages, facilitating the interpretation of the service lifetime of the entire system.

Thus, it is possible to calculate the average permeance P̅ⱼ of the system for component j of the gas from equations 4 and 5 presented below:

$$\overline{{P}_{j}} = \frac{{\sum }_{i = 1}^{2} Δ {p}_{i , j} {A}_{i} {P}_{i , j}^{*}}{{\sum }_{i = 1}^{2} Δ {p}_{i , j} {A}_{i}} \qquad ( 4 )$$

$$Δ {p}_{i , j} = ( {p}_{feed i} {y}_{feed i , j} ) - ( {p}_{perm i} {y}_{perm i , j} ) \qquad ( 5 )$$

where:
P̅ⱼ is the average permeance of the system for component j;

$${P}_{i , j}^{*}$$

is the flux-normalized permeance of component j in stage i;
Aᵢ is the permeation area of the membranes of stage i;
Δp_{i,j} is the partial pressure difference between feed and permeate of component j in stage i;
p_{feed i} is the feed pressure in stage i;
y_{feed i,j} is the gas content in the feed of component j in stage i;
p_{perm i} is the permeate pressure in stage i; and
y_{perm i,j} is the content in the permeate of component j in stage i.

Again, for the monitoring proposed herein, the parameters corresponded to CO₂ in the gas.

### RSL Estimate

By performing the steps established previously in monitoring the permeances of the stages and the entire system over time, it is possible to obtain temporal data of these variables. With these results, it is possible to perform analyses, evaluations, and inferences about how the average permeance behaves over time.

A possible and interesting evaluation is to perform a regression from the permeance estimates obtained by the methodology presented here. With the curve established by the regression, it is possible to extrapolate the dynamic behavior of degradation of the membranes, in order to allow a prediction of the service life. One type of regression that proves suitable for use with these permeance data is Robust Regression.

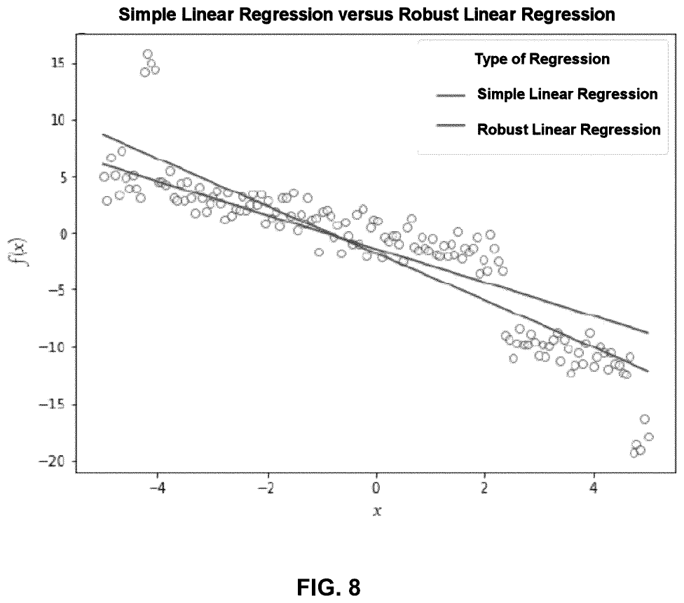

Robustness, from a statistical point of view, refers to how insensitive a given technique is to the presence of “outliers”. The median, for example, is considered a more robust estimator than the average for the same data set. Similarly, several techniques considered robust are proposed for the linear regression problem. Among them, the repeated median method, proposed by Siegel, is particularly interesting for its robustness, speed and insensitivity to spurious values in up to 50% of the sample. FIG. 8 shows the application of the repeated median technique, comparing it to the simple least squares technique, for two data sets.

The presence of “outliers” or even disturbances in the behavior of the data can make the method of simple linear regression difficult in predicting data behavior trends. FIG. 8 shows that the differences between the straight lines are considerable and, and taking into account the phenomenon to be verified by regression, the errors estimated by the simple linear regression may lead to an inefficient process for a longer period. Because of that, throughout the RSL estimation analyses, the robust linear regression technique was employed on the average permeance data.

### Results

In order to validate the proposed methodology, two analyses were conducted on actual data from membrane units: an “offline” analysis, whose objective was to observe the degradation of the membrane performance in the long term; and another “online” analysis, for real-time monitoring of the performance indicators and RSL.

### Offline Results

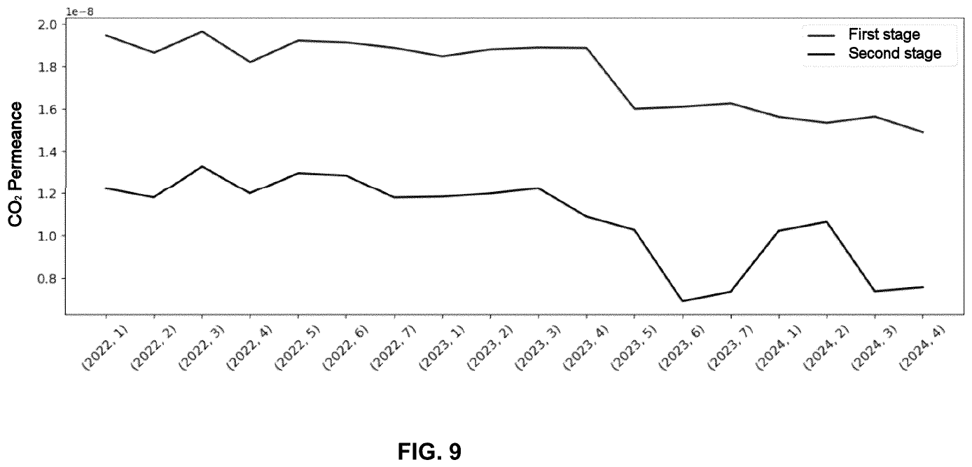

Historical data dating back to the beginning of the operation of the membranes of an oil production platform were submitted to the proposed methodology. It was expected that, in this way, it would be possible to observe the degradation of the corrected KPI over the years of operation. To enable the analysis of the developed library, the data were obtained at bimonthly intervals. To ensure the representativeness of this information, rigorous analyses of the operating modes and the presence of “outliers” were conducted for each time window. FIG. 9 shows the permeance results obtained by the developed library for each bimester period throughout the operation. The trend curves, even without the applicable corrections, show a downward trend for both the first and second stages. The estimated permeances for the first stage, in turn, are usually higher than those estimated for the second stage. This is related to the greater degradation of the second stage. Due to the permeation process in which there is a loss of light hydrocarbons to the permeate stream, the operating gas of the second stage has a higher dew point, being more susceptible to condensation, and, consequently, degradation.

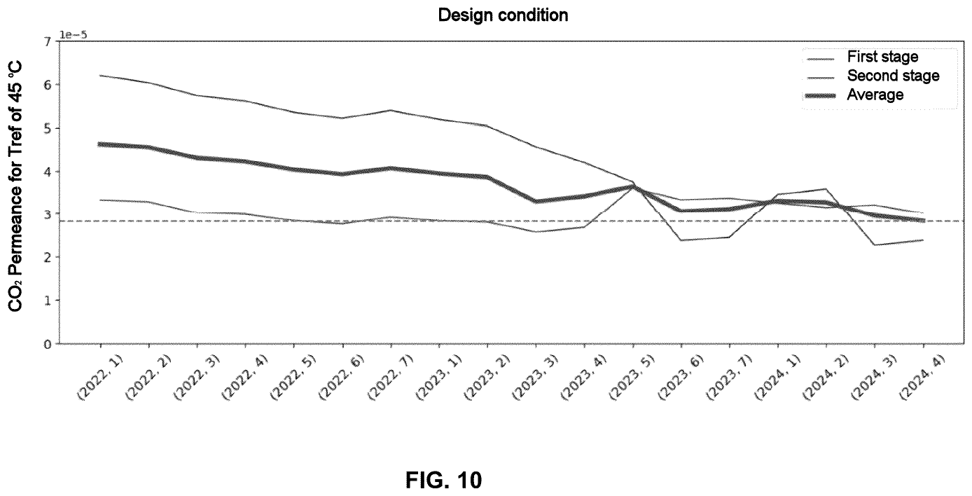

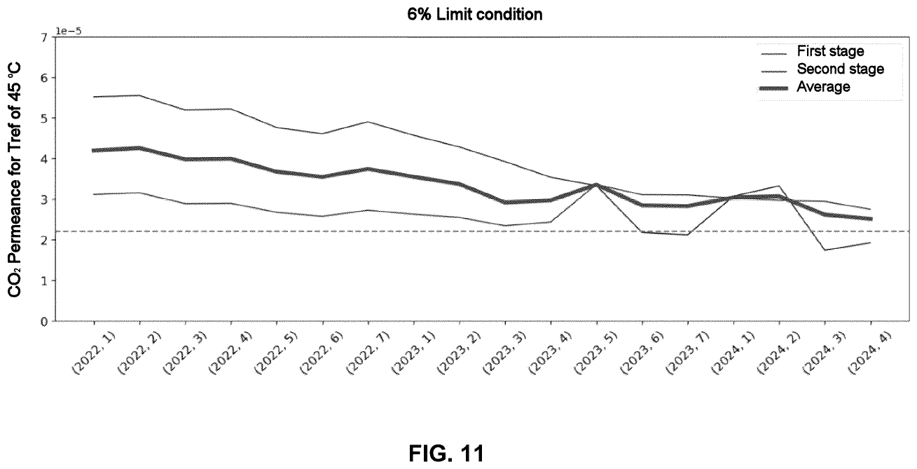

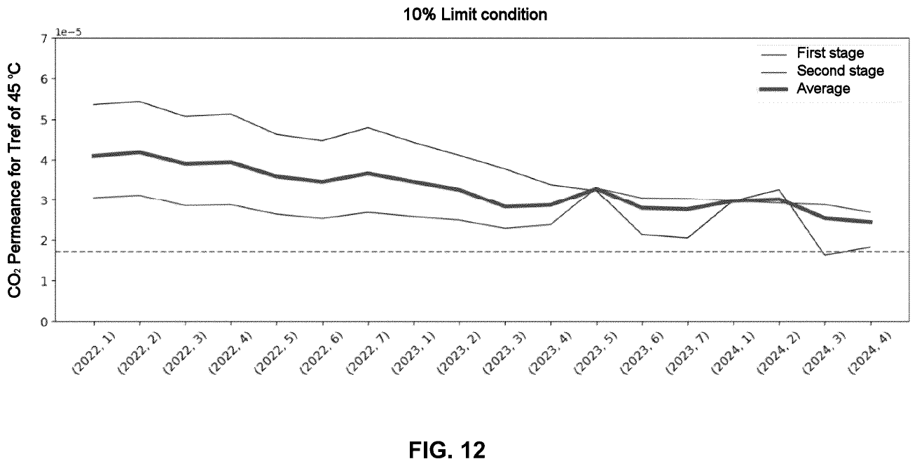

FIGS. 10, 11 and 12 show the same results as FIG. 8, but corrected according to the systematics presented by FIG. 1 for each reference case of FIG. 5, that is, taking into account the gas specification at 3%, 6% and 10%, respectively. The curve highlighted in green shows the average permeance, obtained according to the calculations presented in the section “Obtaining an average permeance of the system” above.

As can be seen, as the flexibility of the CO₂ content in the treated gas increases, there is a distancing between the average permeance curve and the lower limit calculated for a temperature of 45° C., as shown in FIG. 7. In other words, allowing a higher CO₂ content in the exported gas increases the margin between the membrane permeance and the lower limit. Assuming the rigor foreseen by the design condition, it can be observed that the pre-membrane+membrane assembly, represented by the green weighting, reaches its limit in the fourth bimester of 2024. This observation is coherent with the actual operation of the membranes. On the other hand, it is expected that, for a specification of 6% or 10% CO₂, it will be possible to extend the service life of these membranes.

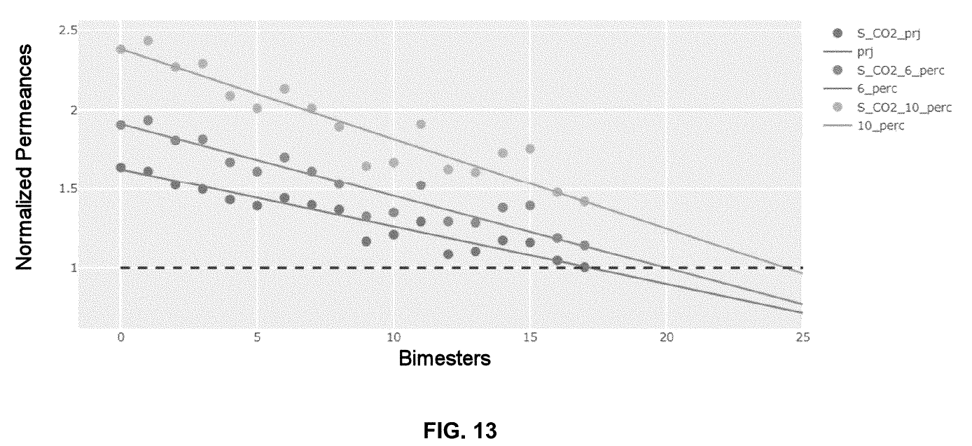

FIG. 13 shows the results of the average permeances over time, linearly extrapolated using the robust regression methodology discussed earlier, where the dark blue points are the estimated permeances for a 3% CO₂ fitting and the red line is the average of these values calculated by robust linear regression, the green points are the estimated permeances for a 6% CO₂ fitting and the purple line is the average of these values calculated by robust linear regression, and the orange points are the estimated permeances for a 10% CO₂ fitting and the light blue line is the average of these values calculated by robust linear regression.

As can be observed, increasing the flexibility of the CO₂ content causes the time horizon required for the average permeances to reach the established limit to increase. In this way, it is possible to quantify the expected service lifetime of the membranes in different scenarios, taking into account the main process factors, such as temperature and flow rate.

### Online Results

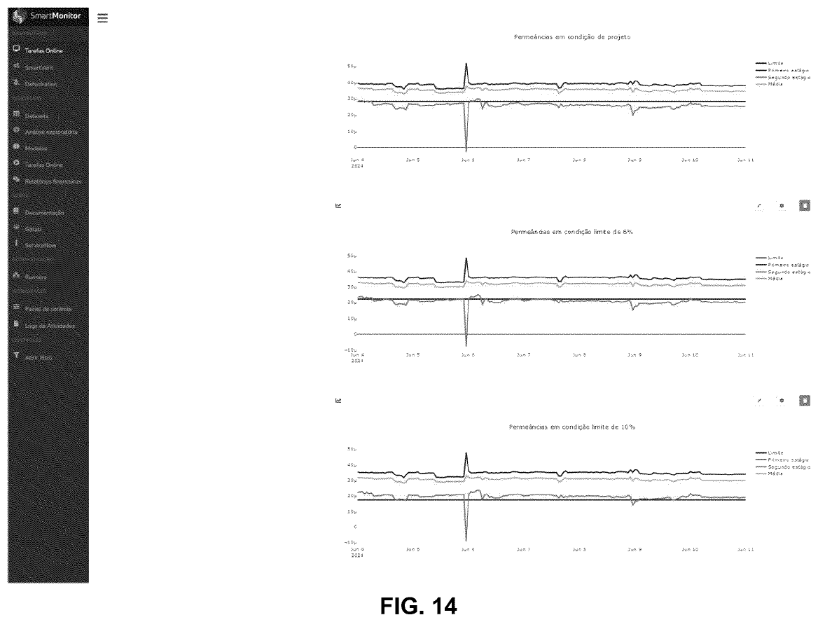

The methodology validated by historical results, as seen above, was replicated on the SmartMonitor platform (Anzai, T. K., Furtado, P. H. T., de Brito, G. M., Santos, J. S., Moreira, P. C. M., Diehl, F. C., Ferreira, L. E. L., Grava, W. M., 2023. Catching Failures in 10 Minutes: An Approach to No Code, Fast Track, AI-Based Real Time Process Monitoring. Offshore Technol. Conf. Bras. OTCB 2023 1-11. https://doi.org/10.4043/32898-MS) for real-time monitoring and proper storage of KPIs. The results generated by SmartMonitor can be recorded in the PI system (PI System™) or monitored by SmartMonitor itself, through configurable dashboards. FIG. 14 shows the monitoring of the permeances for different CO₂ fitting references, using dashboards mounted on the SmartMonitor itself.

As can be observed, as discussed earlier for the historical analysis, the greater the flexibility of gas fitting, the further the average permeances are from the reference curve. By performing real-time analyses, SmartMonitor also allows the calculations predicted by FIG. 1 to be performed at a higher frequency than the bimonthly window adopted in the historical evaluation. This allows for more punctual monitoring of the process, but makes it difficult to identify long-term dynamics.

The advantages of the present disclosure will be immediate for those skilled in the art, among which there can be highlighted:

The disclosure solves or minimizes the difficulties of the state of the art described above by introducing an innovative methodology to estimate the remaining service lifetime (RSL) of the CO₂ removal membranes in a robust and well-founded manner.

The disclosure uses indicators coherent with the physics of the membrane system, enabling a more precise evaluation of the actual condition of these equipment. For this purpose, calculated permeance data are corrected for temperature and flow, in order to minimize the impact of the operating conditions on monitoring and predictions. These indicators, corrected by the proposed method, can be extrapolated in order to determine the time required for a given limit reference condition to be reached.

The validation step with historical data demonstrated that the method is able to correctly detect and predict the decline in the membrane performance over the years. With this predictive capability, the method enables real-time monitoring of the membranes, allowing operational maneuvers to be performed to maximize their campaign time.

In addition, the greater predictability provided by the precise estimation of RSL allows for more assertive and efficient exchange operations, resulting in greater membrane availability and reduced costs associated with reactive maintenances.

In this way, the disclosure directly addresses the limitations of current methods, offering a practical and efficient solution for the predictive monitoring of the CO₂ removal membranes.

Although the aspects of the present disclosure may be subject to various modifications and alternative forms, specific embodiments have been shown by way of example in the drawings and have been described in detail in this document. But it should be understood that the disclosure is not intended to be limited to the particular disclosed forms. Instead, the disclosure should encompass all modifications, equivalents and alternatives that fall within the scope of the disclosure, as defined by the following attached claims.

1. A method for estimating the remaining service life (RSL) of CO₂ removal membranes, comprising:
a) inferring a permeance of a CO₂ removal membrane;
b) obtaining a permeance vs. feed temperature curve;
c) defining a reference temperature (T_{ref});
d) correcting a permeance inference;
e) determining the reference permeance for the defined T_{ref},
f) normalizing the permeance by the volumetric gas flow per stage of the CO₂ removal membrane;
g) repeating steps (b) to (f) at different times of use of the CO₂ removal membrane;
h) obtaining a normalized permeance vs. time curve based on the normalized permeances obtained in step (g); and
i) estimating the RSL of the membrane based on the normalized permeance vs. time curve obtained in step (g) by using a robust linear regression.

2. The method according to claim 1, wherein step (f) is performed according to equations 1, 2 and 3:
$${P}_{i , j}^{*} = \frac{{P}_{i , j}^{T}}{{Flow}_{i , j}} \qquad ( 1 )$$
$${Flow}_{i , j} = \frac{{Q}_{i} {y}_{i , j}}{{A}_{i}} \qquad ( 2 )$$
$${A}_{i} = {\sum }_{k = 1}^{3} F {V}_{k , i} {A}_{k , i} \qquad ( 3 )$$
wherein:
$${P}_{i , j}^{T}$$
is the permeance corrected by temperature T of component j in stage i;
$${P}_{i , j}^{*}$$
is the flux-normalized permeance of component j in stage i;
Flow_{i,j} is the gas flow of component j in stage i;
Qᵢ is the volumetric gas flow rate, under normal conditions, in stage i;
y_{i,j} is the gas content of component j in stage i;
Aᵢ is the permeation area of the membranes of stage i;
FV_{k,i} is the status of the inlet valve of the k-train of the stage i of membranes; and
A_{k,i} is the area corresponding to the elements of the k-train of the stage i of membranes.

3. The method according to claim 2, further comprising a plurality of CO₂ removal membranes, and wherein step (f) is performed for each CO₂ removal membrane, and wherein the method further comprises the step of:
f2) calculating the average permeance of the plurality of membranes from equations 4 and 5:
$$\overline{{P}_{j}} = \frac{{\sum }_{i = 1}^{2} Δ {p}_{i , j} {A}_{i} {P}_{i , j}^{*}}{{\sum }_{i = 1}^{2} Δ {p}_{i , j} {A}_{i}} \qquad ( 4 )$$
$$Δ {p}_{i , j} = ( {p}_{feed i} {y}_{feed i , j} ) - ( {p}_{perm i} {y}_{perm i , j} ) \qquad ( 5 )$$
where:
P̅ⱼ is the average permeance of the system for component j;
$${P}_{i , j}^{*}$$
is the flux-normalized permeance of component j in stage i;
Aᵢ is the permeation area of the membranes of stage i;
Δp_{i,j} is the partial pressure difference between feed and permeate of component j in stage i;
p_{feed i} is the feed pressure in stage i;
y_{feed i,j} is the gas content in the feed of component j in stage i;
p_{perm i} is the permeate pressure in stage i; and
y_{perm i,j} is the content in the permeate of component j in stage i.

4. The method according to claim 1, wherein step (a) comprises:
a1) performing data pre-treatment, wherein the data comprises the following measured variables:
Total Feed Flow Rate (F), Total Retentate Flow Rate (R), and Train A, B and C Retentate Flow Rate (RA, RB and RC);
Molar compositions of: methane (C₁), ethane (C₂), propane (C₃), (i-butane) (iC₄), i-pentane (iC₅), n-butane (nC₄), n-pentane (nC₅), carbon dioxide (CO₂), nitrogen (N₂), hydrogen sulfide (H₂S), and remaining components heavier than pentane (C₆₊) in the aforementioned flows (F), (R), and (RA, RB, and RC);
Feed Pressure (Pf), Retentate Pressure (Pr), and Permeate Pressure (Pp); and
Feed Temperature (Tf) and Retentate Temperature (Tr);
a2) performing Data Reconciliation (DR);
a3) performing Global Energy Balance (GEB);
a4) estimating the total Permeate flow rate (P) and the Permeate temperature (Tp) based on the measured variables and steps (a2) and (a3);
a5) performing Parameter Estimation (PE); and
a6) estimating KPIs (Key Performance Indicators), wherein the KPIs are Selectivity, Dew Point Temperature, and Hydrocarbon (HC) Loss;
wherein a normalization constant for permeances in the model is
$${S}_{max} = 3 \times 1 {0}^{- 7} [ \frac{{MSm}^{3}}{dia \times {m}^{2} \times bar} ] .$$
